(19) United States
(12) Patent Application Publication
(10) Pub. No.: US 2004/0096089 A1
(43) Pub. Date: May 20, 2004

(54) Non-invasive functional imaging of peripheral nervous system activation in humans and animals

(76) Inventors: David Borsook, Concord, MA (US); Lino R. Becerra, Cambridge, MA (US); Alexandre F.A. DaSilva, Brighton, MA (US)

Correspondence Address: DALY, CROWLEY & MOFFORD, LLP, SUITE 101, 275 TURNPIKE STREET, CANTON, MA, 02021-2310, US

(21) Appl. No.: 10/641,481

(22) Filed: Aug. 15, 2003

Related U.S. Application Data
(60) Provisional application No. 60/404,083, filed on Aug. 16, 2002.

(51) Int. Cl. G06K 9/00

(52) U.S. Cl. 382/131

(57) ABSTRACT

A functional magnetic resonance imaging (fMRI) of the peripheral nervous system (PNS), and in particular the trigeminal ganglion (TG), to determine activation in response to sensory input. The sensory input may, for example, be application of heat and/or mechanical stimuli to the face to produce pain.

### CROSS REFERENCE TO RELATED APPLICATIONS

This application claims the benefit of U.S. Provisional Patent Application No. 60/404,083 (Attorney Docket No. MGH-019PUSP), filed Aug. 16, 2002, which is incorporated herein by reference in its entirety for all purposes.

### BACKGROUND

The invention relates generally to non-invasive measurement of neuronal activity during pain states.

The peripheral nervous system (PNS) includes ganglia composed of sensory neurons. These sensory neurons maintain the integrity of fibers (in the periphery) involved in sensation including touch and pain. Under normal conditions, primary afferent nerves, e.g., those located in the dorsal root ganglion (DRG) and trigeminal ganglion (TG), convey sensory information, including pain information, to the central nervous system (CNS). Following peripheral inflammation or nerve damage, there are significant anatomical and functional changes within these sensory neurons that contribute to the clinical pain state.

Recent advances in functional neuroimaging provide for non-invasive measurement of neuronal activation. In particular, functional Magnetic Resonance Imaging (fMRI) uses the Blood Oxygen Level Dependent (BOLD) effect to determine activation within brain regions of humans and animals.

To date, fMRI applications have been limited to the CNS. Pain response measured by such applications is quite complex, however, and does not allow pain states or the effects of pain therapies, including drugs and gene products, to be evaluated on primary afferent fibers in an objective manner in living humans.

### SUMMARY

In one aspect of the invention, the invention provides methods of and apparatus for imaging. The methods include applying sensory stimulation to one or more subjects, acquiring imaging data including functional imaging data of a portion of the peripheral nervous system (PNS), in each of the subjects, the functional imaging data being acquired while the sensory stimulation is applied, and deriving functional activation maps from the functional imaging data.

Embodiments of the invention may include one or more of the following features.

Deriving the functional activation maps can include generating statistical information from the functional imaging data.

The functional imaging data can be processed prior to generating the statistical information.

Deriving the functional activation maps can further include analyzing the functional imaging data for each of the subjects individually and analyzing the functional imaging data for the one or more subjects as a group.

The processing can include correcting image artifacts in the functional imaging data due to movement which occurred while acquiring the functional imaging data.

The processing can further include: maintaining the functional imaging data as a native data set of functional imaging data; registering the functional imaging data to a Talairach brain atlas to produce a first normalized data set of functional imaging data; normalizing the intensity of data in the first normalized data set to produce a second normalized set; applying to the second normalized data set a first spatial filter; averaging data in the second normalized data set; and applying to the native data set a second spatial filter for native individual analysis, the second spatial filter being narrower than the first spatial filter. The spatial filters can be of an isotropic or non-isotropic nature.

The generation of the statistical information can be based on the student t-test.

The analysis of the functional imaging data can further include translating individual and group statistical data based on results of a statistical test into −log P images (or Z images) and rendering the −log P images (or Z images) as color-coded intensity maps of activation which occurred in response to the sensory stimulation.

Acquiring the imaging data can further include acquiring anatomical imaging data and registering the anatomical imaging data to the Talairach brain atlas.

Acquiring the imaging data can be applied to a trigeminal ganglion portion of the peripheral nervous system.

The registered anatomical imaging data can be used to shadow transform the color-coded intensity maps for localization of the trigeminal ganglion.

The sensory stimulation can include thermal pain and/or mechanical stimulation.

The sensory stimulation can be applied to sites on the face of each of the subjects, where the sites correspond to branches of the trigeminal nerve.

In another aspect of the invention, an article includes a storage medium having stored thereon instructions that when executed by a machine result in the following:

analyzing functional image data of the peripheral nervous system (ganglia) acquired for one or more subjects while sensory stimulation is applied to such one or more subjects, to produce functional activation maps.

In yet another aspect of the invention, a system includes a scanner to acquire functional imaging data of the peripheral nervous system while sensory stimulus is applied to one or more subjects, and a data analyzer to operative to produce, from the functional imaging data, functional activation maps from information responsive to the stimulus.

Particular implementations of the invention may provide one or more of the following advantages. The PNS functional imaging approach provides for an objective evaluation of pain response/activation and may be further extended to provide for useful information on analgesic specificity in the periphery as well as clinical evaluation on functional integrity of the trigeminal nerve. Also, the characteristics and location of the trigeminal ganglion of the PNS make that structure a fairly well-defined target for fMRI scans.

Other features and advantages of the invention will be apparent from the following detailed description and from the claims.

### DESCRIPTION OF DRAWINGS

FIGS. 1A-1B show a diagrammatic view of the trigeminal ganglion (TG) of the peripheral nervous system (PNS).

FIG. 1C is a schematic representation of the trigeminal system.

FIG. 1D is a representation of a face that shows facial “stimulation” sites within the distribution of each of the three divisions of the trigeminal nerve.

FIG. 1E is a depiction of a 3-D reconstruction of the right side of the face of a subject stimulated in the “V2” division of the trigeminal nerve.

FIG. 1F is an illustration that shows, for a predicted activation, the relative (x, y and z) positions of the three divisions of the trigeminal nerve and locations of predicted activations in the TG following stimulation of each division in the horizontal and coronal planes.

FIG. 2 is a flow diagram of a process for capturing and analyzing activation in the TG that is responsive to a sensory input.

FIG. 3 is a flow diagram of a data acquisition stage of the process of FIG. 2.

FIG. 4 is a flow diagram of a pre-statistical analysis processing stage of the process of FIG. 2.

FIG. 5 is an illustration of a trace technique used to determine the location of the TG.

FIG. 6 is a block diagram of an exemplary system that operates to perform the process of FIG. 2.

FIGS. 7A-7B show group activation processing results in a temporal display (FIG. 7A) and Fourier analysis plot (FIG. 7B).

FIGS. 8A-8H show V2 activation processing results in the form of activation maps (FIGS. 8A-8D) and temporal displays (FIGS. 8E-8H) for individual subjects.

FIGS. 9A-9F show activation maps for coronal, sagittal and horizontal slices in response to brush (FIGS. 9A-9C) and heat (FIGS. 9D-9F) stimuli for individual subjects.

FIGS. 10A-10D show activation maps for coronal and horizontal slices for activations in V1, V2 and V3 in response to heat and brush stimuli for individual subjects.

FIGS. 10E and 10F show locations of predicted activations of each division in the coronal and horizontal planes, respectively.

FIGS. 11A-11I show activation maps for coronal and horizontal slices for activations in V1, V2 and V3 (FIGS. 11A-11F) and corresponding temporal displays (FIGS. 11G-11I) in response to brush stimuli for a group of subjects.

FIGS. 12A-12I show activation maps for coronal and horizontal slices for activations in V1, V2 and V3 (FIGS. 12A-12F) and corresponding temporal displays (FIGS. 12G-12I) in response to heat stimuli for a group of subjects.

### DETAILED DESCRIPTION

The ability to gather functional information on the peripheral nervous system (PNS) in living humans and animals in healthy and diseased (pain) conditions can provide an avenue for understanding pain condition, as well as for understanding analgesic or other therapeutic compounds or responses (e.g., gene therapy such as retrograde viral approaches to replacing gene products within the ganglion) in patients.

According to techniques and mechanisms to be described below, objective pain response (functional activation) data of the somatosensory portion of the PNS can be acquired via functional magnetic resonance imaging (fMRI) of the trigeminal ganglion (TG) in a subject while applying a sensory stimulation to the subject, e.g., the subject's face.

The PNS consists of the nerves and ganglia outside the brain and spinal cord, and serves to carry information to and from the central nervous system. The ganglia include the dorsal root ganglion (DRG), which provides sensory information from the periphery of the body (from the neck down) to the brain. The ganglia further include the TG, which is the trigeminal nerve's equivalent of the DRG in the body and, unlike the DRG, resides in the brain.

The TG is located at the base of the brain in the posterior cranial fossa across the superior border of the petrous temporal bone. Emanating from the TG are three branches or divisions of the trigeminal nerve, the ophthalmic (V1, sensory), maxillary (V2, sensory) and mandibular (V3, sensory and motor) branches. The ophthalmic branch arises from the upper part of the TG, and passes forward along the lateral wall of the cavernous sinus, below the oculomotor and trochlear nerves. The maxillary branch begins at the middle of the TG and passes horizontally forward, leaving the skull through the foramen rotundum. The mandibular branch leaves the skull through the foramen ovale. Each branch divides into numerous smaller nerves. The nerves from the ophthalmic branch go to the scalp, forehead and the area around the eye. The nerves from the maxillary branch go to the area around the cheek. The nerves from the mandibular branch go to the area from the lower jaw to above the ear. These small nerves send sensations of touch and pain back down the trigeminal nerve to the brain from all areas of the face, lips, teeth and mouth.

Useful functional activation data on the trigeminal portion of the somatosensory system is therefore gathered by directing functional magnetic resonance imaging (fMRI) scans at the TG in a subject while applying a sensory stimulation to facial regions corresponding to the three trigeminal nerve branches V1-V3. The TG is selected because of its location and characteristics. The TG is located at the base of the brain and in the posterior cranial fossa across the superior border of the petrous temporal bone. It comprises sensory neurons from the ophthalmic, maxillary and mandibular divisions of the trigeminal nerve. The TG occupies a cavity (the so-called Meckel's Cave) formed by an invagination of the dura mater. The TG is somewhat crescent-shaped, with its convexity directed forward, and has some somatotopic organization related to the afferent projections from each division. Thus, the structure of the TG is fixed in position and has specific landmarks definable on an MRI film. Although the minimal number of neurons required for functional activation in the brain is unknown, the concentration of neurons within the TG, its fixed anatomy (i.e., not altered by cardiac or respiratory pulsations) and a pattern of vascularization similar to that seen in the CNS make the TG a good target for functional imaging. Thus, a specific unambiguous region of interest (ROI) can be defined anatomically and functionally.

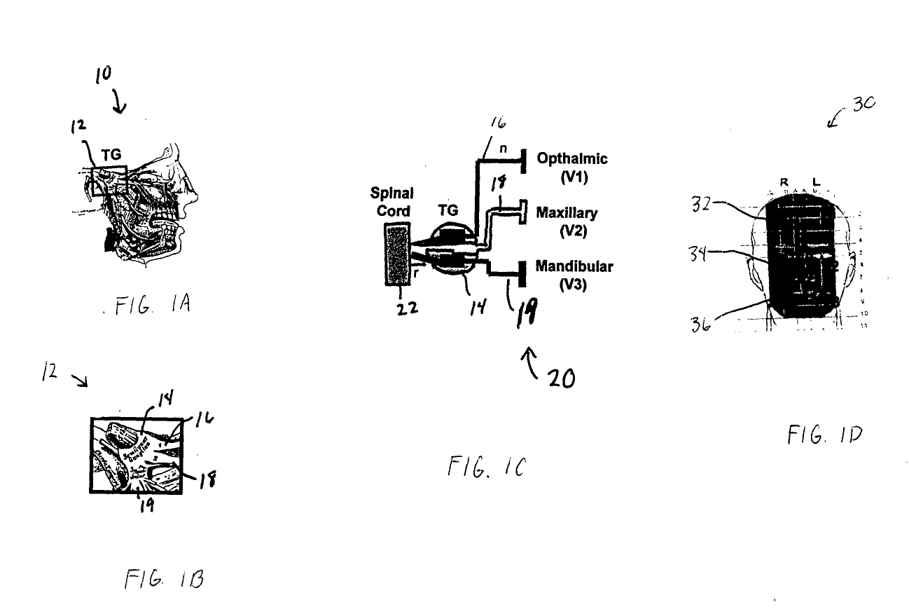

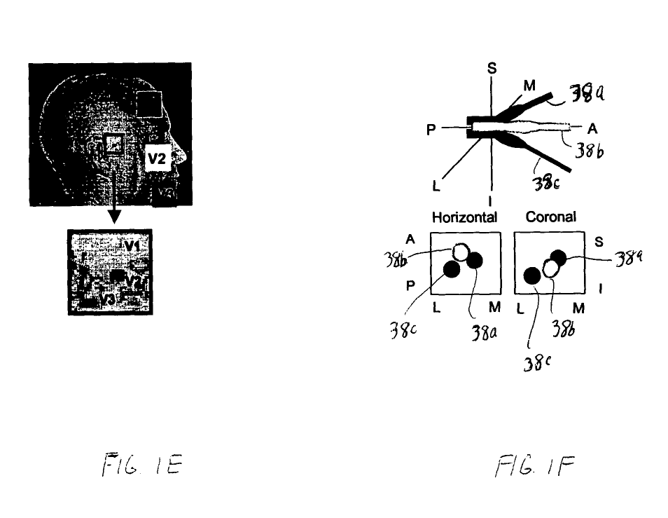

Referring to FIG. 1A, a diagrammatic representation of an anatomical, partial side view of the human head 10 shows a region of the brain, region 12. As shown in the close-up view of FIG. 1B, the region 12 includes TG 14 as well as V1, V2 and V3 divisions 16, 18 and 19, respectively. FIG. 1C shows a schematic representation of a trigeminal system 20 including spinal cord 22, the TG 14 and trigeminal nerve divisions V1 16, V2 18 and V3 19. The neuronal bodies of these nerves are segregated somatotopically within the TC 14 as indicated by the small boxes for each nerve. The central processes of TG neurons (dorsal roots) project to central terminations within the trigeminal nuclear complex (spV) of the brainstem. FIG. 1D shows a facial representation 30 with a mapping of the V1, V2 and V3 divisions to specific corresponding “stimulation” sites on the face, that is, stimulation sites 32, 34 and 36 respectively, with V1 mapping to stimulation site 32, V2 mapping to stimulation site 34 and V3 mapping to stimulation site 34. As will be described later, stimuli are applied to the sites 32, 34, 36 regions within the receptive fields of each of the three divisions (V1, V2 and V3) of the trigeminal nerve. It will be understood that the stimulution sites could be on the mouth, nose, teeth or lips of a subject as well.

Referring to FIG. 1E, a 3-D reconstruction of the right side of the face of a subject stimulated in the V2 region is shown, along with an enlarged view the trigeminal ganglion. Note that activation can be observed within the V2 distribution of the ganglion.

FIG. 1F shows, for a predicted activation, the relative (x, y and z) positions of the V1, V2 and V3 divisions 18, 18 and 19, respectively of the trigeminal nerve within the trigeminal fossa (indicated by reference numerals 38a, 38b and 38c, respectively). Also shown are the locations of predicted activations in the TG following stimulation of each division in the coronal and horizontal planes (again indicated by 38a, 38b and 38c, corresponding to V1, V2 and V3, respectively.

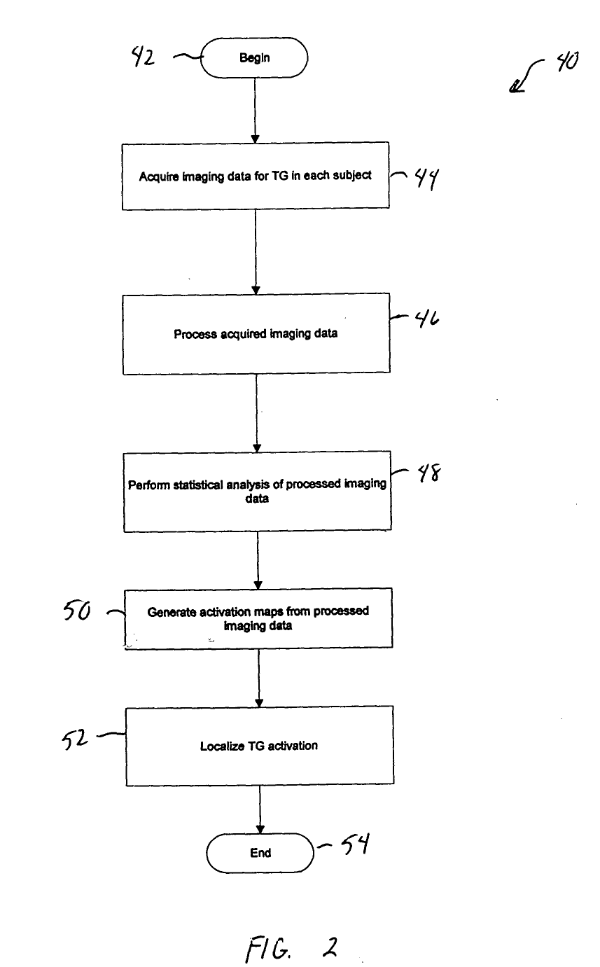

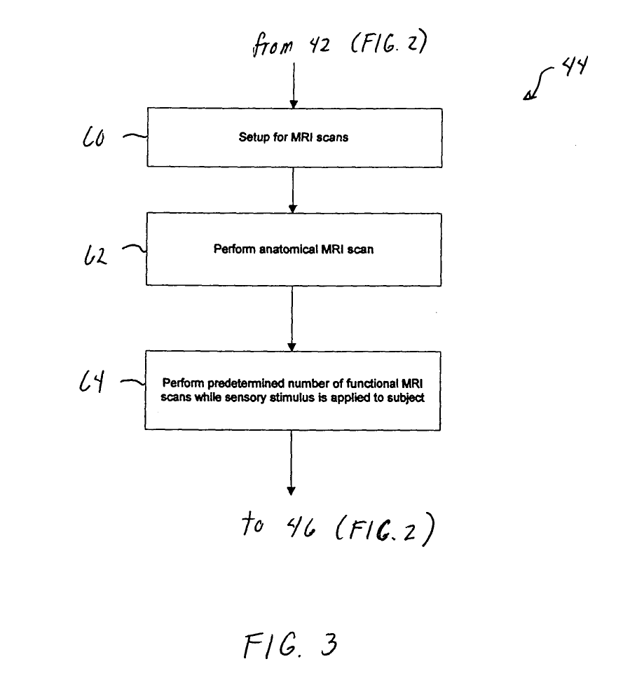

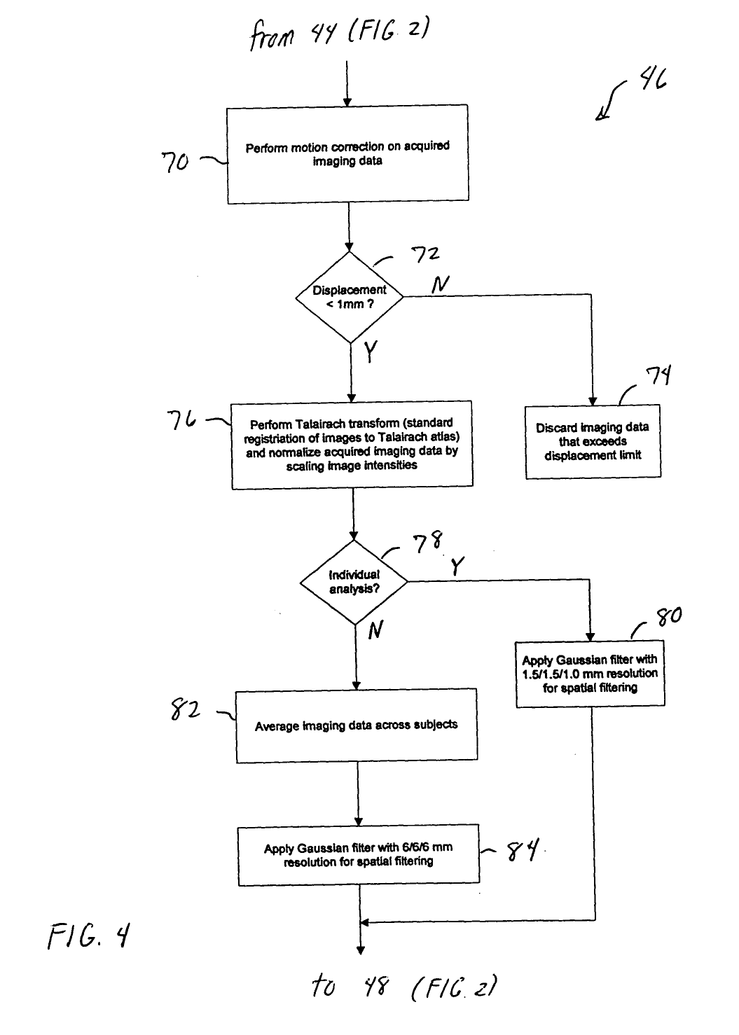

Referring to FIG. 2, an overview of an exemplary image capture and analysis process 40 that utilizes fMRI in the manner discussed above is shown. The process 40 begins (step 42) with an acquisition of imaging data for the TG in each subject (step 44). Once the imaging data has been collected and saved, it may be “pre-processed” or prepared for statistical analysis (step 46). That is, one or more pre-processing techniques may be applied to the imaging data to improve the detection of activation events. A statistical analysis of the pre-processed imaging data is performed (step 48), and from the results of that statistical analysis activation maps are generated (step 50). The TG activation is localized (step 52) and the process terminates (step 54).

The aim of the statistical analysis is to determine those regions in the collected images in which the fMRI signal changes upon stimulus presentation. For such analysis, it is also necessary to quantify how much confidence can be placed in the results, that is to say, what is the probability that a random response could be falsely labeled as activation.

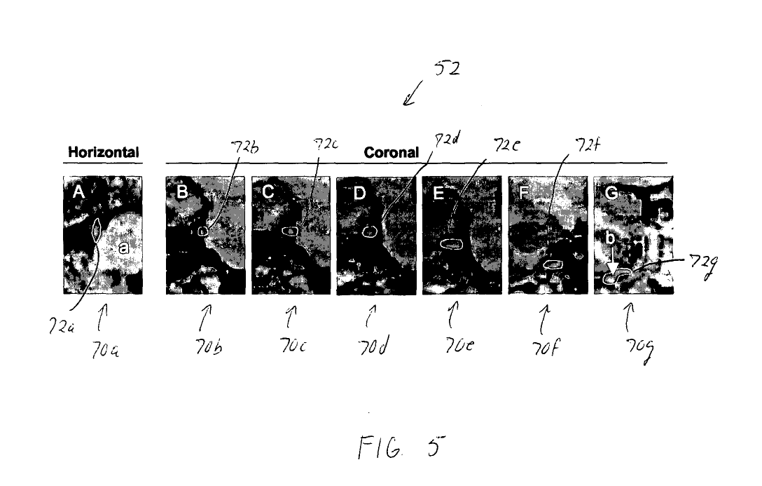

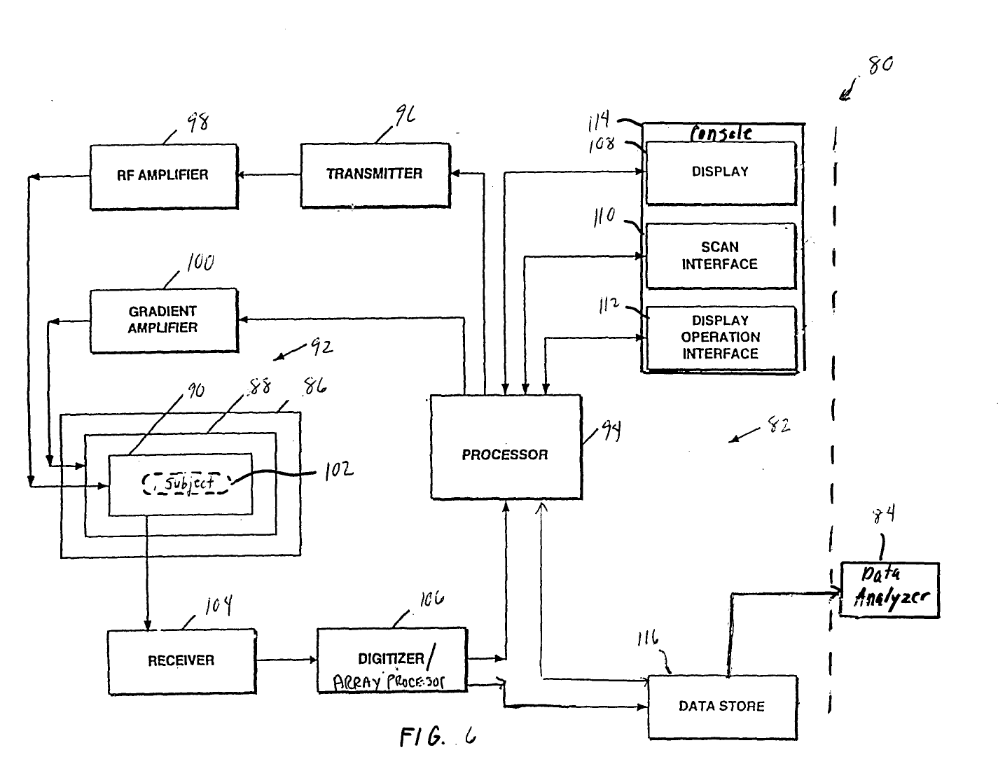

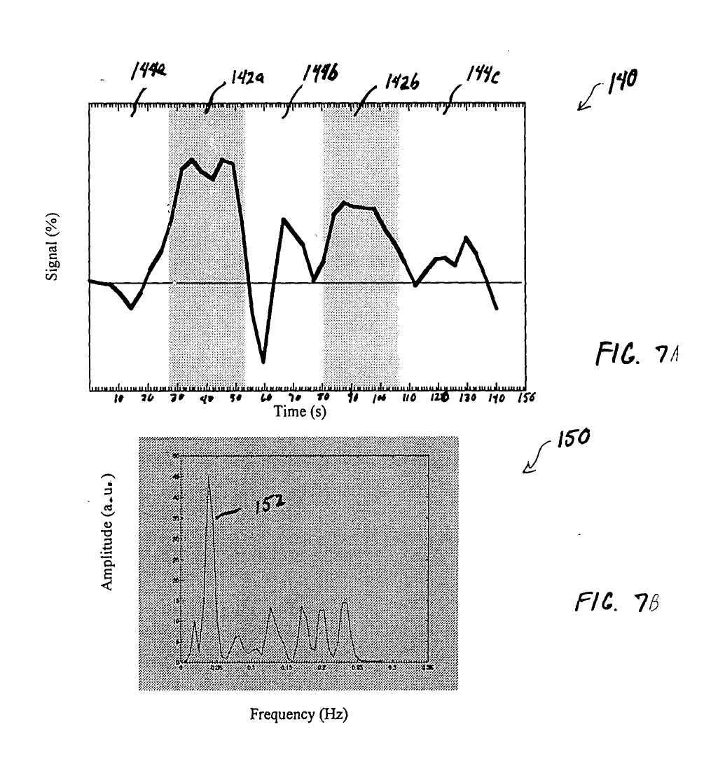

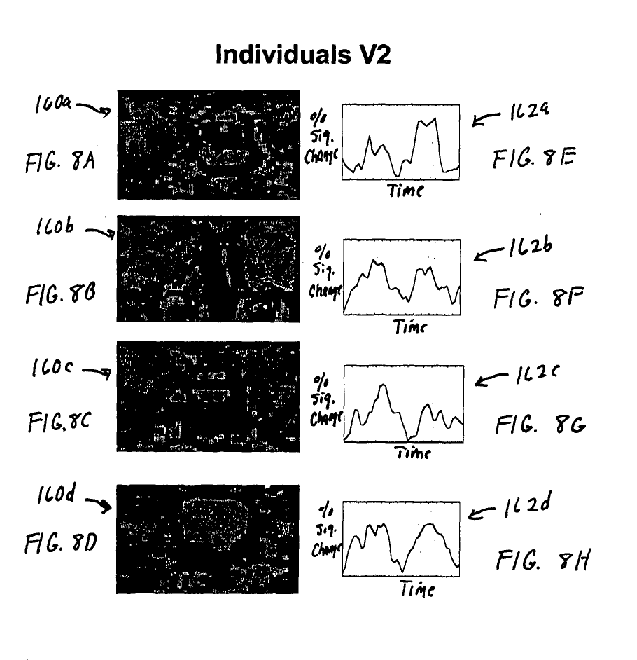

Referring to FIG. 3, the details of the imaging data acquisition 44 are shown. Prior to scanning, the MRI scanning equipment (described later with reference to FIG. 6) is set with the appropriate imaging data acquisition setup information, such as scanning sequence information. An anatomical (or structural) MRI scan is performed to capture the structure of the brain with high resolution (step 62). After the anatomical MRI scan is completed, a predetermined number of functional MRI scans are performed while sensory stimulation is applied to the subject (step 64). More specifically, the sensory stimulation is applied to each of the stimulation sites, as discussed earlier, in turn. The sensory stimulation includes pain stimulation. In one embodiment, and as will be described in further detail later, the pain stimulation includes a mechanical stimulation, e.g., the application of a brush to the skin (at each of the stimulation sites) and a thermal pain stimulation. The anatomical and functional MRI scans are performed for each subject.

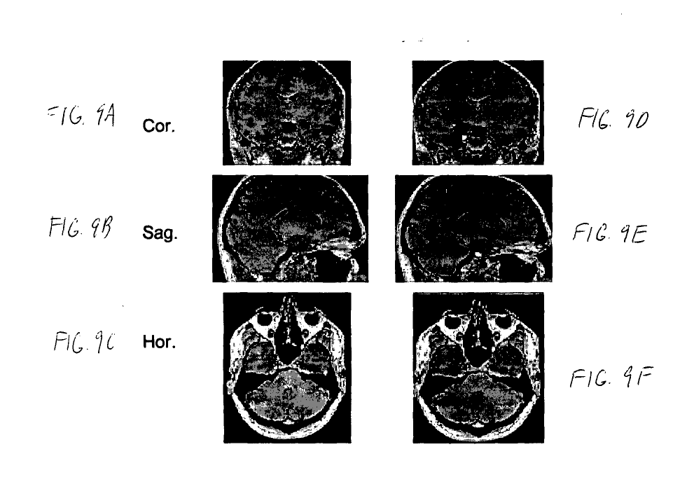

Referring to FIG. 4, the details of the pre-processing stage 46 of the process 40 are shown. The pre-processing stage 46 includes motion correction to remove any artifacts introduced by movement during the scanning procedure (step 70). Subject head movement during fMRI scanning is a major source of artifact in fMRI data. Changes in pixel intensity at the edges of the brain, upon even slight movement, can be far greater than the BOLD activation response. It is common therefore to perform correction that reduces the effect of motion. One well-known technique corrects for in-plane translations and rotations of the head within an image. Working on a slice-by-slice basis, the first image is taken to be the reference image, to which all other images of that slice are to be aligned. Two dimensional rotations and translations are applied to the second image, and the sum of the squares of the difference (SSD) between pixels in the first and second image are calculated. Further translations and rotations are applied to the image until the SSD is minimized. This motion correction routine can be extended to three dimensions to more fully correct for the head motion. Other motion corrections include removal of cardiac and respiratory effects.

The pre-processing stage 46 further includes determining if the displacement of detected subject movement exceeds a threshold limit (step 72). Preferably, the displacement threshold limit is based on the size and location of the imaged structure. In the case of the TG, for example, a 1 mm displacement threshold limit is selected, but other displacement threshold limits could be used. If, at step 72, it is determined that displacement exceeds the displacement threshold limit for a given image, that image is discarded (step 74). The images of the acceptable imaging data are registered to the Talairach brain atlas to normalize differences between the brains of different subjects and, in order to reduce to effect of fluctuations in global intensity, global intensity of each image is normalized by scaling image intensities (step 76). The Talairach transform and global intensity normalization can be accomplished using well-known routines or techniques. Details of the Talairach coordinate system are described in a paper by J. Talairach and P. Tornoux, entitled “Co-planar Stereotactic Atlas of the Human Brain,” Stuttgart, Germany: Beorg Thieme Verlag, 1988. It should be noted that, although the TG is not a part of the Talairach brain atlas per se and thus cannot be defined by the Talairach brain atlas, the Talairach brain atlas can be used to provide information about TG position and movement relative to other structures which are part of the Talairach organization.

The pre-processing 46 determines if the imaging data is to be analyzed for individual subjects as well as for the subjects taken as a group. If an individual analysis is to be performed, the pre-processing 46 applies a first 3-D Gaussian filter to only the non-Talairach or “native” image data (subject images as they were prior to registration and normalization at step 76) for spatial filtering. Spatial filtering smoothes the data to improve signal-to-noise ratio (SNR). In the illustrated embodiment, the first filter has a resolution of 1.5 mm×1.5 mm×1.0 mm (with 1.5 mm being used for both the AP and SI axes, and 1.0 mm corresponding to the ML axis). The spatial filters may be of an isotropic or non-isotropic nature.

The Talairach-registered and normalized images are averaged across subjects for further reduction of noise contribution (step 82), and a second Gaussian filer is applied to the data for spatial filtering (step 84). In the illustrated embodiment, the second filter has a resolution of 6 mm×6 mm×6 mm. The statistical analysis (step 48, FIG. 2) follows the filtering at steps 80 and 84, for the filtered results of both of those steps, that is, for the filtered Talairach and filtered native imaging data.

As noted earlier, spatial filtering to reduce random noise in the image improves the ability of a statistical technique to detect true activations. Spatially smoothing each of the images improves the SNR, but also reduces the resolution in each image, and so a balance must be found between improving the SNR and maintaining the resolution of the functional image. In the illustrated embodiment, a narrower filter is used for the native data to avoid the degree of smearing achieved with wider filters, thus maintaining the resolution (for the individual analysis) at the expense of noise reduction. Although not shown, improvements in the SNR can be made by smoothing in the temporal domain as well.

During statistical analysis (step 48), student T-test data (or data resulting from some other type of statistical test) is produced for the individual “native” data sets and the Talairach/averaged data sets. This is a voxel-by-voxel analysis which compares the noxious thermal stimulus (46° C.) to baseline period (32° C.). During activation map generation step 50, the statistical data are translated into −log P maps (or, alternatively, Z maps or images). These maps are used to color-code intensity of activation. These activation maps are shadow-transformed into anatomical native and Talairach images for localization of the region of interest (ROI) during step 52. The individual Talairach activation is validated only if located within 3 pixels from the average group peak activation coordinates.

Referring to FIG. 5, an exemplary technique used for localization of the TR activation 52 (from FIG. 2) is illustrated pictorially. Serial T-2 weighted sections 70a-70g of standard MRI images of the base of the brain indicate the path to follow in determining the location of the trigeminal ganglion. To localize the functional activation in the trigeminal ganglion using fMRI, the emergence of the trigeminal root from the midlateral surface of the pons is first defined (see region 72a in section 70a). From there, the technique calls for following the trigeminal root pathway until the Meckel's Cave, in the floor of the middle cranial fossa, where the trigeminal ganglion is formed (see regions 72b through 72g in serial sections 70b through 70g, respectively). Additional anatomical landmarks that can be used include the superior orbital fissure (which delimits the anterior border of the trigeminal ganglion for the ophthalmic extension), as well as the foramen rotundum for the maxillary and mandibular extensions.

Referring to FIG. 6, an exemplary system 80 that is operated to perform the process 40 (from FIG. 2) is shown. The system 80 includes a magnetic resonance imaging (MRI) system 82 coupled to a data analyzer 84. The MRI system 82 is configured to non-invasively aid in the capture of functional activation. The data analyzer 84 is configured to use the output of the system 82 for analysis, e.g., statistical analysis, and activation mapping. Thus, the system 82 performs steps 62 and 64 of step 44 (process 44, FIG. 2) according to and in response to user input, including system setup information, while the data analyzer performs the processing of steps 46, 48 and 40 (of process 44, FIG. 2).

The system 82 includes a magnet 86 having gradient coils 88 and RF coils 90 disposed thereabout in a particular manner to provide a magnet system 92. In response to control signals provided from a processor or computer 94, a transmitter 96 provides a transmit signal to the RF coil 90 through an RF power amplifier 98. A gradient amplifier 100 provides a signal to the gradient coils 88 also in response to signals provided by the processor 94. Thus, the magnet system 92 is driven by the transmitter 96 and amplifiers 98, 100. The transmitter 96 generates a steady magnetic field and the gradient amplifier 100 provides a magnetic field gradient that may have an arbitrary direction. For generating a uniform, steady magnetic field required for MRI, the magnet system 92 may be provided having a resistance or superconducting coils and which are driven by a generator. The magnetic fields are generated in an examination or scanning space or region 102 in which the subject or portion of the subject to be examined is disposed.

The transmitter/amplifier 96, 98 drive the RF coil 86. After activation of the RF coil 86, spin resonance signals are generated in the subject situated in the examination space 102, which signals are detected and are applied to a receiver 104. Depending upon the measuring technique to be executed, the same coil can be used for the transmitter coil and the receiver coil or use can be made of separate coils for transmission and reception. The detected resonance signals are sampled, digitized in a digitizer 106. Digitizer 106 converts the analog signals to a stream of digital bits that represent the measured data and provides the bit stream to the processor 94.

The processor 94 processes the resonance signals measured so as to obtain an image of the excited part of the object. A display 108 coupled to the processor 94 is provided for the display of the reconstructed image. The display 108 may be provided for example as a monitor, a terminal, such as a CRT or flat panel display. The components 108, 110 and 112 may reside in a single control console unit 114, as shown.

As discussed earlier, a user (system operator) provides scan and display operation commands and parameters to the processor 94 through a scan interface 110 and a display operation interface 112, each of which provide means for a user to interface with and control the operating parameters of the MRI system 82 in a manner well known to those of ordinary skill in the art. Thus, an operator of the system 82 gives input to the processor 94 through the control console 114. An imaging sequence is selected and customized from the console. The operator can see the images on the display 110 located on the console, or could make hard copies of the images on a film printer (not shown).

In addition, the system 82 can include data store 116 for storing output of the digitizer 106 and processor 94. The imaging data output of the processor 94, stored in the data store 116, can be retrieved by the data analyzer 84 for further processing.

Each of the components of system 82 is standard equipment in commercially available magnetic resonance imaging systems, such as the imagers in the Siemens MAGNETOM product line. In some embodiments, the data analyzer may be provided as a general purpose processor or a computer system, such as a personal computer (PC) or work station having a processor programmed in accordance with the techniques described herein to analyze the imaging data acquired by the MRI system 82. For example, a PC (or other computing device) may be loaded with custom software or a commercially available medical imaging analysis software package, such as Medx from Sensor Systems, which may be customized for specific user parameter values and so forth, that executes to perform data analysis (steps 46, 48 and 50, FIG. 2) as well as produce output (e.g., activation maps) for presentation to the user.

FIGS. 7-11 illustrate output of the process 40 when employed for an experiment conducted using a group of subjects, specifically, nine healthy right-handed males having a mean age of 29.4±5.05 years. The subjects had no history of significant dental or facial pain, were not on any medication, and were instructed not to consume caffeine since the night before the experiment.

The subjects received an explanation of the experiment protocol, including the nature of the research, the temporal sequence, the device to be utilized for thermal pain stimulation, and how to rate their pain (0-10/Likert Visual Analogue Scale). During the functional MRI scans, the subjects were instructed to not move the head, and maintain the eyes closed. At any time the subjects could halt the experiment by activating a safety mechanism held in one hand.

The overall approach to the experimental paradigm and analysis is as follows. Subjects received sensory stimulation that included a mechanical (brush) stimulation and a thermal (pain) stimulation. The mechanical stimuli were applied to each of the 3 divisions of the trigeminal nerve within stimulation sites (as shown in FIG. 1D) corresponding to the same 1.6×1.6 cm pre-marked areas of the skin used for thermal stimulation. The mechanical stimuli were applied sequentially, in separate fMRI acquisitions, to each of the sites using a brush attached to a mechanical transducer designed for use in the magnet. The brush stimuli were applied with a frequency of 1-2 Hz. The brush was not alternated with heat since the latter could sensitize the skin. Continuous brush stimulation was applied 4 times, each time for 25 seconds with an inter-stimulus interval of 30 seconds. The thermal pain stimulation was applied to the same pre-marked sites of three divisions of the right trigeminal nerve using a 1.6×1.6 cm Peltier thermode. Each site received a stimulus trial of two painful stimuli of 46° C. in a block designed mode of 25 seconds each, separated by three 30 seconds baseline stimuli of 32° C. Pain levels were rated using the Likert scale, where 0 corresponded to a condition of “no pain” and 10 corresponded to a condition of “maximal pain imaginable.” The two brush stimuli were administered prior to two thermal stimuli (46° C.).

During the sensory stimulation, anatomical and functional MRI scanning was performed to collect the image data. The scanner used in the experiment was the Siemens MAGNETOM Sonata System 1.5T. After a 3-plane scout scan, the axial and coronal scouts were utilized for the placement of the 3D anatomical sagittal scan. The functional MRI runs were prescribed with 45 time-points of 30 slices, each 3 mm thick, oriented parallel to the medulla in an oblique plane (TR/TE=3.5s/40 ms, in-plane resolution of 3.125 mm), including the middle portion of the forebrain, brainstem and trigeminal ganglion. The fMRI images were acquired as individual functional data sets. The functional data was processed as described earlier with reference to FIGS. 2 and 4.

The trigeminal ganglion, approximately 1.5×1 cm in size, was visualized within the acquired brain slices. The anatomical contribution of each of the three divisions of the trigeminal nerve (V1, V2, and V3) in the formation of the trigeminal ganglion could be seen in the results.

The psychophysical ratings were as follows. No pain was reported following the brush stimuli. The average pain scores based on the visual analogue scale of 0 (no pain) to 10 (highest pain imaginable) for the thermal pain stimuli were 6.2±1.0 (n=6) for the V1 area, 6.6±0.6 (n=7) for the V2 area and 5.5±1.0 (n=5) for the V3 area. The value “n” corresponds to the number of subjects included in the fMRI data analysis.

FIG. 7A shows a temporal display 140 of signal change (%) as a function of time (in seconds). The shaded regions 142a and 142b correspond to time intervals in which the pain stimulus was applied to the subjects. The un-shaded regions 144a, 144b and 144c correspond to time intervals in which the neutral (or no) stimulus was applied to the subjects. FIG. 7B shows a plot of amplitude versus frequency 150 corresponding to a Fourier transform of the fMRI signal for activation in V2. A 0.05 Hz peak, indicated by reference numeral 152, corresponds to the frequency of the stimulus. The Fourier analysis is used to evaluate the correlation of the signal change with the application of the stimulus and other potential influences. It is used to rule out the possible contribution of pulsations originating from the carotid artery. The results, as shown in the plot 150, indicate how little noise contributed to the signal as a whole. Significantly, no activation was present on the contralateral side in the same location of the trigeminal ganglion.

FIGS. 8A-8D show activation maps 160a-160d, respectively, for activation within V2 for individual subjects. FIGS. 8E-8H show temporal displays (such as the one described earlier with reference to FIG. 7B) 162a-162, respectively, corresponding to the activations of activation maps 160a-160d, respectively.

FIGS. 9A-F show, for the individual analysis, the TG activation in response to brush and heat stimuli. The figures show statistical maps of activations within the maxillary (V2) division of the trigeminal nucleus following brush stimulation (FIGS. 9A-C) and noxious heat stimulation (FIGS. 9D-F).

Examples of individual activation are shown in FIGS. 10A-10D for brush and for heat stimuli. FIG. 10A and FIG. 10B show coronal slice 170a and horizontal slice 170b, respectively, for thermal pain stimulation. FIG. 10C and FIG. 10D show coronal slice 170c and horizontal slice 170d for brush stimulation. Activation regions 172a, 172b, 172c and 172d in slices 170a, 170b, 170c and 170d, respectively, show the contributions of all three divisions V1, V1 and V3. The divisions V1, V2 and V3 are indicated by the same reference numerals 173a, 173b and 173d, respectively, in close-ups (square insets) of the activation regions in each of the slices. Note how these activations correspond to predicted activations in these two planes, shown in FIGS. 10E and 10F, respectively (and as shown earlier in FIG. 1F).

FIGS. 10A-10C show average statistical activation maps of the coronal plane for the V1, V2 and V3 divisions, reference numerals 180a, 180b, 180c, respectively, and FIGS. 10D-10F show activation maps of the horizontal planes for the V1, V2 and V3 divisions, reference numerals 180d, 180e, 180f, respectively, in the TG following brush stimulation for the group. In particular, FIGS. 10A and 10D show activation 182, 184 respectively, observed following stimuli to the face within the ophthalmic division V1. FIGS. 10B and 10E shows activation 186, 188, respectively, observed following stimuli to the face within the maxillary division V2. FIGS. 10C and 10F show activation 190, 192, respectively, observed following stimuli to the face within the mandibular division V3 of the nerve. Arrows in the figures point to the activations.

FIGS. 10G-10I show temporal displays 194, 196, 198 of relative (%) signal change (y-axis) over time in seconds (x-axis) for six subjects (n=6), seven subjects (n=7) and five subjects (n=5), respectively. The displays 194, 196 and 198 correspond to the activation shown in FIGS. 10A-10D, FIGS. 10B-10E and FIGS. 10C-10F, respectively. Activations are time-locked with the stimulus presentation as shown by the shaded bars.

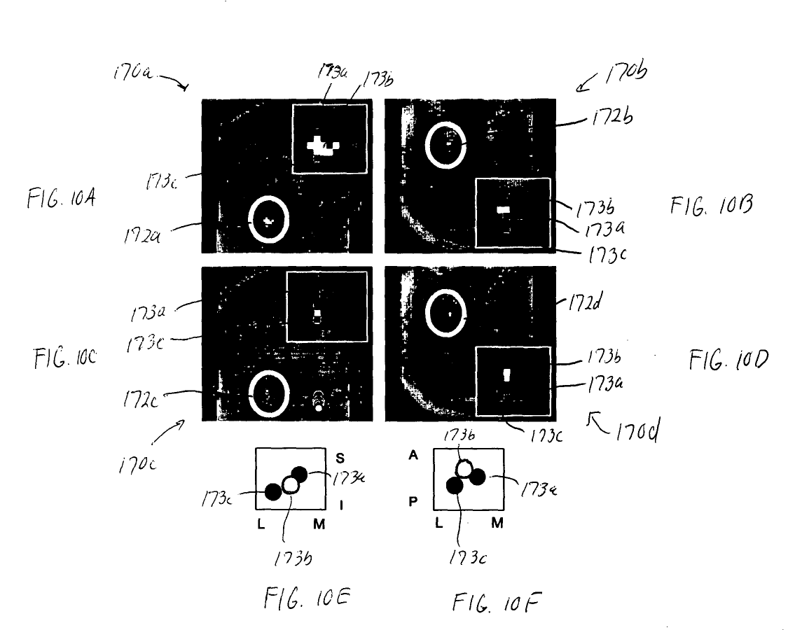

FIGS. 11A-11C show statistical activation maps of the coronal plane for the V1, V2 and V3 divisions, reference numerals 200a, 200b, 200c, respectively, and FIGS. 11D-F show activation maps of the horizontal planes for the V1, V2 and V3 divisions, reference numerals 200d, 200e, 200f, respectively, in the right TG following painful heat stimulation for the group. In particular, FIGS. 11A and 11D show activation 202, 204, respectively, observed following stimuli to the face within the ophthalmic division V1. FIGS. 11B and 11E show activation 206, 208, respectively, observed following stimuli to the face within the maxillary division V2. FIGS. 11C and 11F show activation 210, 212, respectively, observed following stimuli to the face within the mandibular division V3 of the nerve.

FIGS. 11G-11I show temporal displays 214, 216, 218 of relative (%) signal change (y-axis) over time in seconds (x-axis) for six subjects (n=6), seven subjects (n=7) and five subjects (n=5), respectively. The displays 214, 216 and 218 correspond to the activation shown in FIGS. 11A-11D, FIGS. 11B-11E and FIGS. 11C-11F, respectively. Activations correspond to the stimulus presentation as shown by the shaded bars.

V1, V2 and V3 data like that shown in FIGS. 10 and 11 may be similarly presented for individual activations as well.

Tables 1 and 2 (below) provide details of the activations including Talairach coordinates, volume of activation and significance of activation (p value) for the group analysis. Table 1 shows results of the thermal positive group analysis and Table 2 shows results of the brush negative group analysis. With respect to the results shown in Table 1, it may be noted that activation for the ophthalmic and mandibular divisions was less significant than that from the maxillary division.

TABLE 1

| Stimulus | Talairach Coordinates | | | Volume | p |
|---|---|---|---|---|---|
| Site | ML(X) | AP(Y) | SI(Z) | (cm³) | value |
| Ophthalmic | 20 | −6 | −30 | 0.22 | 1.0 × 10⁻³ |
| Division (V1) | | | | | |
| Maxillary | 20 | −4 | −34 | 0.38 | 2.5 × 10⁻⁵ |
| Division (V2) | | | | | |
| Mandibular | 20 | −4 | −38 | 0.01 | 3.6 × 10⁻² |
| Division (V3) | | | | | |

TABLE 2

| Stimulus | Talairach Coordinates | | | Volume | p |
|---|---|---|---|---|---|
| Site | ML(X) | AP(Y) | SI(Z) | (cm³) | value |
| Ophthalmic | 14 | −8 | −32 | 0.18 | 4.2 × 10⁻⁴ |
| Division (V1) | | | | | |
| Maxillary | 20 | −2 | −36 | 0.02 | 3.9 × 10⁻² |
| Division (V2) | | | | | |
| Mandibular | 20 | −8 | −34 | 0.07 | 1.5 × 10⁻² |
| Division (V3) | | | | | |

To confirm that individuals contributed to the group activation, data from each individual was analyzed as well. Individual analysis was performed using both the Talairach system and native analysis as described earlier. Table 3 and Table 4 (below) provide details of activation for thermal and brush stimulation, respectively, for the individual analysis. In both tables, the symbol “+” denotes activation, the symbol “−” denotes no activation, the notation “±/(±)” represents “Talairach/(anatomic)” data, the symbol “Δ” denotes movement and the symbol “ø” indicates a machine malfunction. The individual activation was only validated if it was located within 3 pixels from that of average peak coordinates. As indicated in Table 3, activation for heat stimuli was seen for 6/7 from V1, 7/7 from V2 and 5/7 from V3. As indicated in Table 4, activation for the brush stimuli was seen for 6/7 from V1, 6/7 from V2 and 6/7 from V3.

TABLE 3

| Stimulus | Subject Number | | | | | | | |
|---|---|---|---|---|---|---|---|---|
| Site | 1 | 2 | 3 | 4 | 5 | 6 | 7 | Total |
| Ophthalmic | −/(−) | +/(+) | +/(+) | +/(+) | +/(+) | +/(+) | Δ | 5/(6) |
| Division (V1) | | | | | | | | |
| Maxillary | +/(+) | −/(+) | +/(+) | −/(−) | +/(+) | +/(+) | +/(+) | 6/(7) |
| Division (V2) | | | | | | | | |
| Mandibular | −/(+) | ø | ø | −/(−) | +/(+) | +/(+) | −/(−) | 3/(5) |
| Division (V3) | | | | | | | | |

TABLE 3

| Stimulus | Subject Number | | | | | | | |
|---|---|---|---|---|---|---|---|---|
| Site | 1 | 2 | 3 | 4 | 5 | 6 | 7 | Total |
| Ophthalmic | −/(−) | +/(+) | +/(+) | +/(+) | +/(+) | +/(+) | Δ | 5/(6) |
| Division (V1) | | | | | | | | |
| Maxillary | −/(−) | +/(+) | +/(+) | −/(−) | +/(+) | −/(+) | Δ | 4/(6) |
| Division (V2) | | | | | | | | |
| Mandibular | −/(−) | +/(+) | −/(−) | +/(+) | +/(+) | +/(+) | Δ | 4/(6) |
| Division (V3) | | | | | | | | |

The application of either brush or thermal stimuli to the V1, V2 or V3 divisions of the face produced fMRI activation within the ipsilateral trigeminal ganglion in 7 healthy volunteers. Two of nine subjects were excluded because of motion artifact. Activation was present in 6 of 7 subjects for brush for all divisions, and between 5 to 7 of 7 subjects for thermal stimuli (depending on division stimulated). Signal change in the order of 0.4-1.5% was observed in these cases. No activation was seen in the contralateral TG in any subject, suggesting that these activations were caused by the stimuli and are not artifacts.

Each of the three divisions of the trigeminal nerve consists of processes from neurons with cell bodies in the trigeminal ganglion. The neuronal bodies for both large (AB) and small fibers (C and A-delta) are arranged segmentally within the trigeminal ganglion. Cell bodies of the mechanoreceptive and nociceptive afferents of the ophthalmic division (V1) are found medially and anteriorly; those of the mandibular division (V2) are caudal and lateral; and those from the maxillary division are present in between. Thus, the somatotopic activation patterns observed for both brush and thermal pain correspond to the anatomical formulation of the ganglion.

The trigeminal nerve contains both motor and sensory fibers. The primary afferent sensory fibers of all types (Aβ, Aδ (or A-delta) and C) have their neuronal bodies within the TG. Thus, a wealth of information on primary afferent sensory fibers in the TG is therefore available from both human and animal data.

Large myelinated fibers (Aβ) convey a number of sensations including light touch, whereas unmyelinated C and A-delta fibers primarily convey nociceptive information. A large percentage of trigeminal neurons are involved in pain processing. Extracellular recordings in monkeys have revealed activation in TG neurons following thermal stimuli at 38-49° C. Maximum discharge frequencies have been obtained in the noxious heat range (above 44° C.). Experiments have correlated the activation of warm and nociceptive C-fiber afferents in the monkey with human psychophysical measures. The experiments describe herein used a thermal stimulus of 46° C., well above the activation threshold of nociceptors and subjects reported significant pain with this stimulus (VAS scores greater than 5/10), strongly supporting the activation of C fibers by this stimulus.

With respect to functional imaging of the trigeminal ganglion, a number of issues should be considered. These include the ganglion's fixed location, vascularization, and the number of neurons responding within the TG.

The trigeminal nerve is the largest and most complex of the twelve cranial nerves and also the largest “dorsal root ganglion” in the body. It is located at the base of the brain in the posterior cranial fossa within Meckel's Cave. It is thus in a fixed position with clearly marked anatomical features, easily recognized by MRI. In addition, as noted earlier, anatomical scans may be used to trace the dorsal root fibers entering the brainstem back to the TG. The roots start along the ventral surface of the brainstem at the midpontine level and are easily defined by their size and location. The presence of anatomical markers clearly visible on fMRI allows confidence in the localization of the trigeminal ganglion when analyzing the specificity of activation.

The blood supply to the trigeminal ganglion originates from the internal carotid artery via the cavernous sinus. The microcirculatory bed in the TG has been studied anatomically. In the internal layers of perineurium, pericapillaries, capillaries and postcapillaries are present. In the sheaths surrounding the root fibers and in endoneurium, only capillaries are present. Microscopic evaluation of blood vessels within the TG revealed that arteriolo-venular anastomoses facilitate blood redistribution within the superficial layers of the trigeminal nerve and precapillary sphincters and transepineural arterioles are involved in the regulation of blood flow in deeper layers of the nerve trunk. Together, these data suggest that the vascular structure within the TG is similar to that observed within the CNS and should provide a reliable basis for BOLD measures.

Because the internal carotid artery is located medial to the trigeminal ganglion, cardiac pulsation could produce artifacts. These artifacts should appear bilaterally. However, the absence of activation in the contralateral trigeminal ganglion indicates that it was not observed in the data.

Following anatomical localization of the trigeminal ganglion activation using the mechanism described above with reference to FIG. 5, the time course of the signal was checked for temporal correlation with the application of the stimulus (for example, as shown in FIG. 7E). Because the internal carotid artery is located medial to the trigeminal ganglion, the cardiac pulsation could produce motion-related artifact in the proximity of the area. Fourier analysis of the individual and group activation showed that these high-frequency artifacts, also including respiratory movement, did not contribute significantly to the activation in the trigeminal ganglion. Two individuals were eliminated because they exceeded the head movement threshold. The significant movement of the head could produce artifacts that could be falsely interpreted as neuronal activation.

The minimal number of neurons that must be activated to produce a signal detectable by fMRI is not known and the current data adds some useful information regarding this issue. The human TG contains approximately 25,000 neurons. These include all the sensory neurons innervating the face via the trigeminal nerve. In the experiments described above, Stimulation was applied to a small region of the face, corresponding to <5-10% of the total surface area innervated by the ipsilateral trigeminal nerve. Within the group of neurons activated, issues such as frequency of action potentials may be the salient issue in driving measurable BOLD changes. Whatever the underlying basis, the results indicate that activation within quite small populations of neurons can be measured with BOLD.

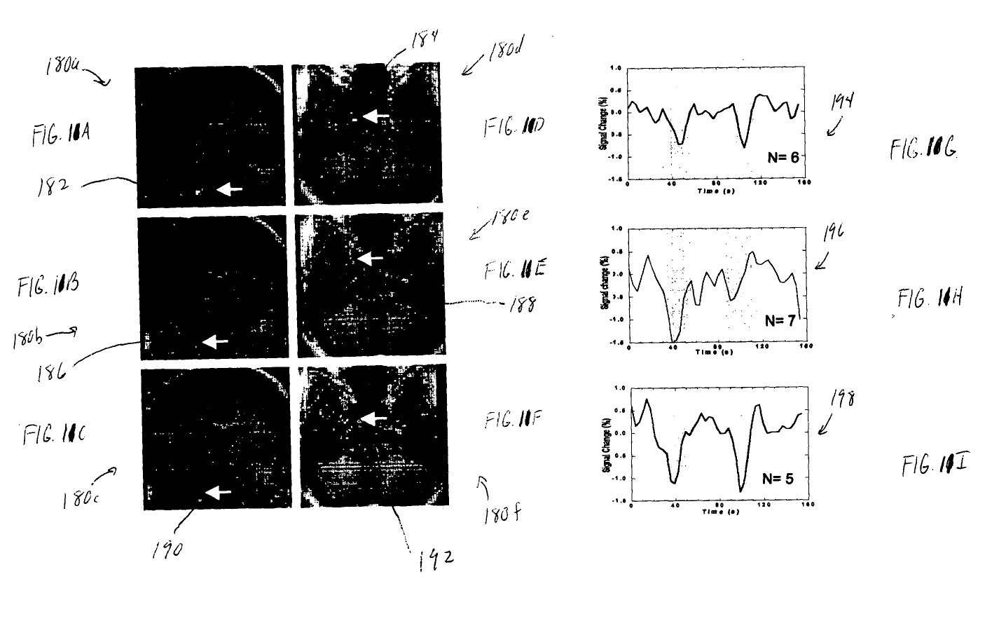

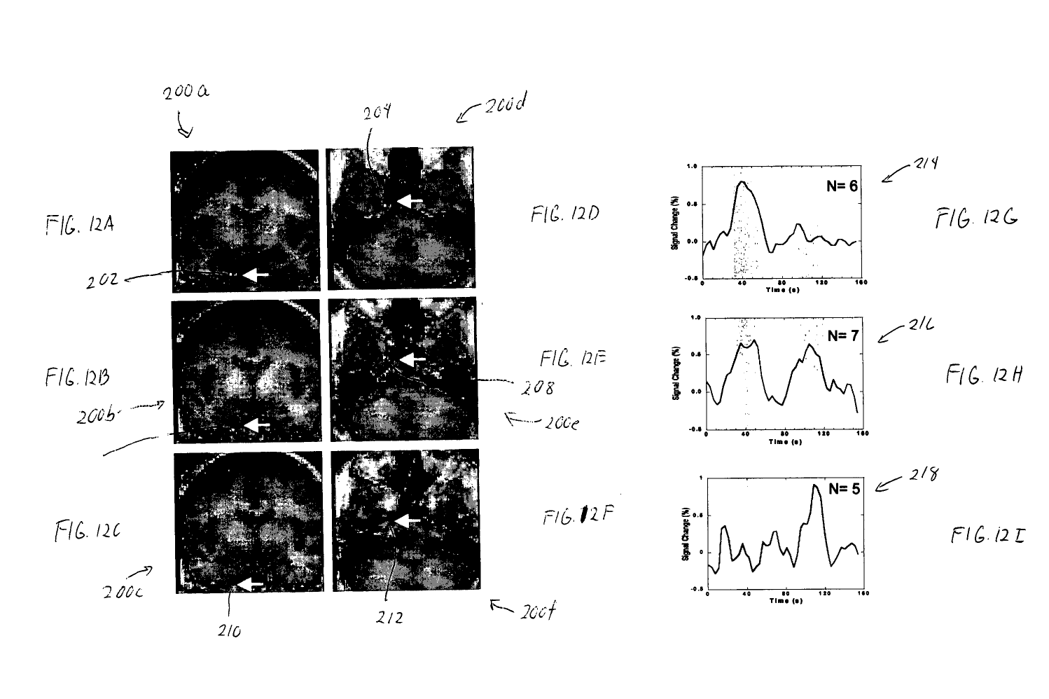

The data presented above show increased BOLD signal (positive signal change) in response to noxious heat (as illustrated in FIGS. 12G and 12I) and decreased BOLD signal (negative signal change) in response to a brush stimulus (and illustrated in FIGS. 11G and 11I). The explanation for this difference in the polarity of signal change may be that these responses take place in separate neural populations. Brush stimuli activate large myelinated Aβ fibers, while noxious thermal heat activates both small unmyelinated (C) and thinly myelinated A-delta fibers. While the Aβ fibers exhibit fast conduction velocities (100 m/s) and rapid re-priming of sodium currents, A-delta and C fibers have slow conducting velocities (5-20 m/s for A-delta and 0.1-1 m/s for C fibers) and slower re-priming of sodium channels. The response in Aβ fibers is an “on-off” response compared with the slower offset of activity in C fibers.

A potential explanation of negative activation to brush but not to heat is as follows.

When noxious heat is applied to the periphery, small fibers (C and A-delta induce a relatively small number of synaptic events, hence an initial dip takes place in the BOLD response because flow by itself does not clear out increase deoxyhemoglobin due to activity. However, blood flow and especially increased blood volume turns the signal around giving a positive response as a result of the augmented capillary volume diluting the concentration of deoxyhemoglobin and makes flow more efficient in removing it. Thus, the positive signal is dependent on the capacity to increase volume and flow. In the case of brush stimulation, the large A-Beta fibers produce more synaptic activity as has been evidenced from electrophysiology experiments. In this case, the required increase in blood flow and volume might not be achieved, and hence the negative signal observed may represent an extended initial dip in the BOLD response. In addition there may be some effects from sympathetic inputs to the ganglion and heat and brush have different effects on sympathetic tone of vessels surrounding the activated neurons. The interpretation of negative signal changes in BOLD signal is still unresolved. The BOLD signal has been correlated with action potentials and slow varying field potentials. In this formulation, inhibitory inter-neurons and dentrites/cell soma are thought to contribute to the signal. The intrinsic TG neurons are bipolar, with no dendrites, and there are no inhibitory interneurons present. The TG does contain sympathetic inputs to the vasculature that may influence neural function. However, the relative structural simplicity of the TG provides a simpler system for interpreting the BOLD response.

In sum, fMRI of the trigeminal ganglion can be performed while sensory stimulation, such as brush stimulation (known to activate Aβ fibers) and/or noxious heat stimulation in the painful range, i.e., >44° C. (known to activate C and Aδ fibers), is applied to each of three divisions of the face in healthy human subjects. That signal changes observed in the ganglion are present only on the ipsilateral side to the stimulus and a somatotopic pattern of activation correlates with the known anatomical segregation of the ophthalmic, maxillary and mandibular divisions of the trigeminal nerve. Results indicate that somatotopic activation within the trigeminal ganglion can be defined using fMRI and further specificity of activation may be observed. This approach, together with mapping of central trigeminal pathways, allows for objective evaluation of clinical conditions (e.g., postherpetic neuralgia affecting the face, damage to trigeminal nerves following dental surgery) and the efficacy of therapies for facial pain.

The above-described techniques can be used in a variety of applications, e.g., to evaluate therapeutic (for example, drug and gene product) action or intervention, to identify novel pain therapeutics, to evaluate damage to the PNS, to analyze BOLD response, as well as other applications. To evaluate damage to the PNS, following nerve damage but prior to a particular course of treatment, such as surgery, stimuli is provided to one or more applicable regions of interest. In conjunction with each stimuli, imaging of a portion of the PNS (e.g., the TG) is performed using the techniques described herein. Thus, a process such as that described in FIGS. 2-4 can be used to produce pre-treatment (e.g., pre-surgery) functional activation maps. After the treatment, the process is repeated to produce post-treatment (in the case of surgery, post-surgery) functional activation maps. The pre- and post-treatment functional activation maps can then be compared to evaluate the state of the PNS portion following treatment. A similar approach can be taken to evaluate a therapeutic intervention. That is, for an objective evaluation of a therapeutic intervention to the PNS, pre- and post-therapeutic intervention functional activation maps can be produced and then compared to evaluate the efficacy of the therapeutic intervention. Likewise, in an evaluation of a candidate therapy such as a drug or gene product, e.g., a clinical drug trial or candidate therapeutic screen, image data (baseline or pre-therapy image data, such as pre-therapy functional activation maps) would be acquired prior to administration of the candidate therapy, and image data (post-therapy image data, such as post-therapy functional activation maps) would be collected after such administration to evaluate the response to the candidate therapy. A candidate therapeutic that reduces the pain response is considered useful as an analgesic. Preferably, the pain response is reduced by at least 5%, more preferably, by at least 10-25%, even more preferably, by at least 40-60%, and most preferably by a least 85%. Therapeutics and drugs according to the invention include any compound, nucleic acid (for example, DNA, RNA, or PNA) or protein.

The process can also be used to evaluate plasticity of the PNS in humans following nerve damage and subsequent treatment. It can also be used to evaluate BOLD response. In a BOLD response evaluation, functional activation maps produced from imaging data acquired while a stimulus is applied to a subject could be compared to functional activation maps produced from imaging data acquired without the application of a stimulus to detect changes in the BOLD response resulting from the stimulation. The BOLD response can be used to determine a positive signal change in response to noxious heat and a negative BOLD signal change in response to a mechanical stimulus. The positive BOLD signal change can be indicative of activation in pain fibers (such as the C and Aδ fibers), while the negative BOLD signal change can be indicative of activation in large sensory fibers (such as the Aβ fibers), as discussed earlier.

Thus, the above-described process provides for non-invasively evaluating pain states or effects of drugs or gene products in an objective manner to elucidate activity within the peripheral nervous system (for example, in the dorsal root ganglion, including the trigeminal ganglion) in humans and animals. Such a screening mechanism, particularly when correlated with the discovery of novel therapies (for example, drugs or gene products) provides a number of significant advantages. For example, it provides a marker that can be evaluated in humans or animals using objective methods of defining CNS circuitry, as well as a marker for evaluating efficacy of analgesics in human pain that can be nearly seamlessly integrated with drug assessment techniques in animals and humans, particularly with regard to techniques such as functional neuroimaging. It also provides a technique for longitudinal evaluation of pain-induced changes within the peripheral nervous system. The peripheral sensory nervous system can be imaged using functional magnetic resonance imaging. Innocuous mechanical and noxious thermal stimuli to the face produce activation in the TG.

Although the approach was described with respect to fMRI scans directed to the TG, it will be appreciated that the approach may be extended to the DRG or other areas of the peripheral nervous system and other types of somatosensory information by adapting the process 40 described above to acquire imaging data from such other areas.

It is to be understood that while the invention has been described in conjunction with the detailed description thereof, the foregoing description is intended to illustrate and not limit the scope of the invention, which is defined by the scope of the appended claims. Other embodiments are within the scope of the following claims.

What is claimed is:

1. A method of imaging comprising:
applying sensory stimulation to one or more subjects;
acquiring imaging data including functional imaging data of a portion of the peripheral nervous system in each of the subjects, the functional imaging data being acquired while the sensory stimulation is applied; and
deriving functional activation maps from the functional imaging data.

2. The method of claim 1 wherein deriving comprises:
generating statistical information from the functional imaging data.

3. The method of claim 2, wherein deriving further comprises:
processing the functional imaging data prior to generating the statistical information.

4. The method of claim 3, wherein deriving further comprises:
analyzing the functional imaging data for each of the subjects individually; and
analyzing the functional imaging data for the one or more subjects as a group.

5. The method of claim 3, wherein processing comprises:
correcting image artifacts in the functional imaging data due to movement that occurred while acquiring the functional imaging data.

6. The method of claim 5, wherein processing further comprises:
maintaining the functional imaging data as a native data set of functional imaging data;
registering the functional imaging data to a Talairach brain atlas to produce a first normalized data set of functional imaging data;
normalizing the intensity of data in the first normalized data set to produce a second normalized data set;
applying to the second normalized data set a first spatial filter;
averaging data in the second normalized data set; and
applying to the native data set a second spatial filter for native individual analysis, the second spatial filter being narrower than the first spatial filter.

7. The method of claim 6, wherein the first spatial filter and the second spatial filter are of either an isotropic or a non-isotropic nature.

8. The method of claim 6, wherein generating the statistical information is based on the student t-test.

9. The method of claim 6, wherein analyzing the functional imaging data further comprises:
translating individual and group statistical data based on results of a statistical test into images comprising at least one of −log P images or Z images; and
rendering the images as color-coded intensity maps of activation that occurred in response to the sensory stimulation.

10. The method of claim 9, wherein acquiring further comprises:
acquiring anatomical imaging data; and the method further comprises
registering the anatomical imaging data to the Talairach brain atlas.

11. The method of claim 1, wherein the step of acquiring is applied to the dorsal root ganglion portion of the peripheral nervous system.

12. The method of claim 1, wherein the step of acquiring is applied to the trigeminal ganglion portion of the peripheral nervous system.

13. The method of claim 12, further comprising:
using the registered anatomical imaging data to shadow transform the color-coded intensity maps for localization of the trigeminal ganglion.

14. The method of claim 1, wherein the sensory stimulation comprises thermal pain stimulation.

15. The method of claim 1, wherein the sensory stimulation comprises mechanical pain stimulation.

16. The method of claim 1, wherein the sensory stimulation is applied to sites on the face of each of the subjects, the sites corresponding to branches of the trigeminal nerve.

17. The method of claim 1, wherein the one or more subjects comprise a human subject.

18. The method of claim 1, wherein the one or more subjects comprise an animal subject.

19. A method for Blood Oxygen Level Dependent (BOLD) response analysis comprising:
acquiring imaging data including functional imaging data of a portion of the peripheral nervous system in a subject;
analyzing the functional imaging data to produce a first functional activation map;
applying sensory stimulation to a subject, the sensory stimulation including noxious heat and mechanical stimulation;
acquiring imaging data including functional imaging data of a portion of the peripheral nervous system in the subject while the stimulation is applied to the subject;
analyzing the functional imaging data to produce one or more second functional activation maps; and
using the first and second functional activation maps to detect changes in BOLD response resulting from the noxious heat and mechanical stimulation.

20. The method of claim 19, wherein using comprises determining a positive BOLD signal change in response to the noxious heat and a negative BOLD signal change in response to the mechanical stimulation.

21. The method of claim 20, wherein the positive BOLD signal change is indicative of activation in pain fibers of the populations of neurons of the peripheral nervous system portion for which imaging data is acquired.

22. The method of claim 20, wherein the negative BOLD signal change is indicative of activation in the large sensory fibers of the populations of neurons of the peripheral nervous system portion for which imaging data is acquired.

23. The method of claim 19, wherein the peripheral nervous system comprises the trigeminal ganglion.

24. A method of evaluating the efficacy of a candidate therapy comprising:
applying sensory stimulation to a subject prior to administering a candidate therapy;
acquiring imaging data including functional imaging data of a portion of the peripheral nervous system in the subject, the functional imaging data being acquired while sensory stimulation is applied;
analyzing the functional imaging data to produce pre-therapy functional activation maps;
applying the sensory stimulation to the subject after the candidate therapy has been administered;
again acquiring the imaging data including the functional imaging data of the portion of the peripheral nervous system;
analyzing the functional imaging data to produce post-therapy functional activation maps; and
comparing the pre-therapy functional activation maps and the post-therapy functional activation maps to evaluate the efficacy of the candidate therapy on the peripheral nervous system.

25. The method of claim 24, wherein the candidate therapy comprises a drug.

26. The method of claim 24, wherein the candidate therapy comprises a gene product.

27. A method for objective evaluation of damage to the peripheral nervous system comprising:
applying sensory stimulation to a subject prior to surgery being performed on the subject;
acquiring imaging data including functional imaging data of a portion of the peripheral nervous system in the subject prior to the surgery, the functional imaging data being acquired while sensory stimulation is applied;
analyzing the functional imaging data to produce pre-surgery functional activation maps;
applying the sensory stimulation to the subject after the surgery has been performed on the subject;
again acquiring the imaging data including the functional imaging data of the same portion of the peripheral nervous system;
analyzing the functional imaging data to produce post-surgery functional activation maps; and
comparing the pre-surgery functional activation maps and the post-surgery functional activation maps to evaluate the state of the portion of the peripheral nervous system following the surgery.

28. A method for objective evaluation of a therapeutic intervention to the peripheral nervous system comprising:
applying sensory stimulation to a subject prior to a therapeutic intervention being performed on the subject;
acquiring imaging data including functional imaging data of a portion of the peripheral nervous system in the subject prior to the therapeutic intervention, the functional imaging data being acquired while sensory stimulation is applied;
analyzing the functional imaging data to produce pre-intervention functional activation maps;
applying the sensory stimulation to the subject after the therapeutic intervention has been performed on the subject;
again acquiring the imaging data including the functional imaging data of the diseased portion;
analyzing the functional imaging data to produce post-intervention functional activation maps; and
comparing the pre-intervention functional activation maps to the post-intervention functional activation maps to evaluate the efficacy of the therapeutic intervention.

29. A system comprising:
a scanner operative to acquire functional imaging data of the peripheral nervous system while a sensory stimulus is applied to one or more subjects; and
a data analyzer operative to produce, from the functional imaging data, functional activation maps from information received responsive to the stimulus.

30. The system of claim 29, wherein the functional imaging data comprises functional imaging data of the trigeminal ganglion portion of the peripheral nervous system.

31. The system of claim 29, wherein the functional imaging data comprises functional imaging data of the dorsal root ganglion portion of the peripheral nervous system.

32. An article comprising:
a storage medium having stored thereon instructions that when executed by a machine result in the following:
analyzing functional image data of the peripheral nervous system acquired for one or more subjects while sensory stimulation is applied to such one or more subjects, to produce functional activation maps.

33. The article of claim 32, wherein analyzing comprises:
generating statistical information from the functional imaging data.

34. The article of claim 32, wherein the instructions further comprise instructions which when executed on a machine result in the following:
processing the functional imaging data prior to generating the statistical information.

35. The article of claim 34, wherein analyzing further comprises:
analyzing the functional imaging data for each of the subjects individually; and
analyzing the functional imaging data for the one or more subjects as a group.

36. The article of claim 34, wherein processing comprises:
correcting image artifacts in the functional imaging data due to movement that occurred while acquiring the functional imaging data.

37. The article of claim 36, wherein processing further comprises:
maintaining the functional imaging data as a native data set of functional imaging data;
registering the functional imaging data to a Talairach brain atlas to produce a first normalized data set of functional imaging data;
normalizing the intensity of data in the first normalized data set to produce a second normalized data set;
applying to the second normalized data set a first spatial filter;
averaging data in the second normalized data set; and
applying to the native data set a second spatial filter for native individual analysis, the second spatial filter being narrower than the first spatial filter.

38. The article of claim 37, wherein the first spatial filter and the second spatial filter are of either an isotropic or a non-isotropic nature.

39. The article of claim 37, wherein generating the statistical information is based on the student t-test.

40. The article of claim 39, wherein analyzing the functional imaging data further comprises:
translating individual and group statistical data based on results of a statistical test into images comprising at least one of −log P images or Z images; and
rendering the images as color-coded intensity maps of activation that occurred in response to the sensory stimulation.

41. The article of claim 40, wherein acquiring further comprises:
acquiring anatomical imaging data; and
registering the anatomical imaging data to the Talairach brain atlas.

42. The article of claim 32, wherein the data is acquired from the trigeminal ganglion portion of the peripheral nervous system.

43. The article of claim 42 wherein the instructions further comprise instructions which when executed on a machine result in the following:
using the registered anatomical imaging data to shadow transform the color-coded intensity maps for localization of the trigeminal ganglion.

44. The article of claim 32, wherein the data is acquired from the dorsal root ganglion portion of the peripheral nervous system.

45. The article of claim 32, wherein the sensory stimulation comprises thermal pain stimulation.

46. The article of claim 45, wherein the sensory stimulation further comprises mechanical pain stimulation.

47. The article of claim 32, wherein the sensory stimulation comprises mechanical pain stimulation.

48. The article of claim 32, wherein the sensory stimulation is applied to sites on the face of each of the subjects, the sites corresponding to branches of the trigeminal nerve.

49. The article of claim 32, wherein the one or more subjects comprise a human subject.

50. The article of claim 32, wherein the one or more subjects comprise an animal subject.

51. An article for Blood Oxygen Level Dependent (BOLD) signal analysis comprising: a storage medium having stored thereon instructions that when executed by a machine result in the following:
acquiring imaging data including functional imaging data of a portion of the peripheral nervous system in a subject;
analyzing the functional imaging data to produce a first functional activation map;
applying sensory stimulation to a subject, the sensory stimulation including noxious heat and mechanical stimulation;
acquiring imaging data including functional imaging data of a portion of the peripheral nervous system in the subject;
analyzing the functional imaging data to produce one or more second functional activation maps; and
using the first and second functional activation maps to detect changes in BOLD response resulting from the noxious heat and mechanical stimulation.

52. The article of claim 51, wherein using comprises determining a positive BOLD signal change in response to the noxious heat and a negative BOLD signal change in response to the mechanical stimulation

53. The article of claim 52, wherein the positive BOLD signal change is indicative of activation in pain fibers of the populations of neurons of the peripheral nervous system portion for which imaging data is acquired.

54. The article of claim 52, wherein the negative BOLD signal change is indicative of activation in the large sensory fibers of the populations of neurons of the peripheral nervous system portion for which imaging data is acquired.

55. The article of claim 51, wherein the peripheral nervous system portion comprises the trigeminal ganglion.

56. An article comprising:
a storage medium having stored thereon instructions that when executed by a machine result in the following:
applying sensory stimulation to a subject prior to administering a therapy;
acquiring imaging data including functional imaging data of a portion of the peripheral nervous system in the subject, the functional imaging data being acquired while sensory stimulation is applied;
analyzing the functional imaging data to produce pre-therapy functional activation maps;
applying the sensory stimulation to the subject after the therapy has been administered;
again acquiring the imaging data including the functional imaging data of the portion of the peripheral nervous system;
analyzing the functional imaging data to produce post-therapy functional activation maps; and
comparing the pre-therapy functional activation maps and the post-therapy functional activation maps to evaluate the effects of the therapy on the peripheral nervous system.

57. The article of claim 56, wherein the therapy comprises a drug treatment.

58. The article of claim 56, wherein the therapy comprises a gene product therapy.

59. An article for objective evaluation of the peripheral nervous system comprising:
a storage medium having stored thereon instructions that when executed by a machine result in the following:
applying sensory stimulation to a subject prior to surgery being performed on the subject;
acquiring imaging data including functional imaging data of a portion of the peripheral nervous system in the subject prior to the surgery, the functional imaging data being acquired while sensory stimulation is applied;
analyzing the functional imaging data to produce pre-surgery functional activation maps;
applying the sensory stimulation to the subject after the surgery has been performed on the subject;
again acquiring the imaging data including the functional imaging data of the same portion of the peripheral nervous system;
analyzing the functional imaging data to produce post-surgery functional activation maps; and
comparing the pre-surgery functional activation maps and the post-surgery functional activation maps to evaluate the state of the portion of the peripheral nervous system following the surgery.

60. An article for objective evaluation of a therapeutic intervention to the peripheral nerve comprising:
a storage medium having stored thereon instructions that when executed by a machine result in the following:
applying sensory stimulation to a subject prior to a therapeutic intervention being performed on the subject;
acquiring imaging data including functional imaging data of a portion of the peripheral nervous system in the subject prior to the therapeutic intervention, the functional imaging data being acquired while sensory stimulation is applied;
analyzing the functional imaging data to produce pre-intervention functional activation maps;
applying the sensory stimulation to the subject after the therapeutic intervention has been performed on the subject;
again acquiring the imaging data including the functional imaging data of the portion of the peripheral nervous system;
analyzing the functional imaging data to produce post-intervention functional activation maps; and
comparing the pre-intervention functional activation maps and the post-intervention functional activation maps to evaluate the efficacy of the therapeutic intervention.

61. An apparatus comprising:
means for applying sensory stimulation to one or more subjects;
means for acquiring imaging data including functional imaging data of a portion of the peripheral nervous system in each of the subjects, the functional imaging data being acquired while sensory stimulation is applied; and
means for analyzing the functional imaging data to generate functional activation maps.

62. An article comprising:
a machine-readable storage medium including, for each of a plurality of subjects, stored results of the step of analyzing functional image data of the peripheral nervous system acquired from each of the subjects while sensory stimulation was applied to such subjects to produce functional activation maps.
